(19) United States
(12) Patent Application Publication
(10) Pub. No.: US 2020/0307436 A1
(43) Pub. Date: Oct. 1, 2020

(54) MOBILE SALON VEHICLE

(71) Applicant: Robert Powell, New York, NY (US)

(72) Inventor: Robert Powell, New York, NY (US)

(21) Appl. No.: 16/366,185

(22) Filed: Mar. 27, 2019

(51) Int. Cl. B60P 3/025; B60N 3/00; B60R 15/02; B60R 16/03; A61H 35/00

(52) U.S. Cl. CPC B60P 3/025; B60N 3/00; A61H 2201/0207; B60R 16/03; A61H 35/006; B60R 15/02

(57) ABSTRACT

A mobile salon vehicle is configured to contain a plurality of spa chairs with an integrated massaging foot spa tub. The mobile salon vehicle includes a generator, a water tank, a water heater, water pump and associated plumbing to service the massaging foot spa tubs. The salon chair may include a full service reclining massaging chair to provide salon services on the go.

### BACKGROUND OF THE INVENTION

The present invention relates to salon services, and more particularly to apparatus and methods for providing mobile salon services.

Until now, there has been no way to provide full service salon services, such as a pedicure as would be done in a conventional building without a rolling mini sink or aftermarket sink built into a vehicle.

Other mobile salons have fixed seats without a massage chair attached to a foot spa with heated plumbing.

As can be seen, there is a need for an apparatus and methods for providing a full service salon services in a mobile environment.

### SUMMARY OF THE INVENTION

In one aspect of the present invention a mobile salon vehicle is disclosed.

The mobile salon vehicle includes a motor vehicle platform having an interior space configurable to a salon interior. A plurality of salon chairs are mounted within the interior space. Each of the plurality of salon chairs has an integrated massaging foot tub. A plumbing system, in communication with a water tank provides a source of water to the massaging foot tub. A generator provides a source of electrical power to the plurality of salon chairs.

In some embodiments, the mobile salon vehicle includes a water heater configured to provide a source of hot water to at least each of the plurality of salon chairs. A water pump may be provided for communicating the source of water through the plumbing system. One or more sinks may be positioned proximal to the plurality of salon chairs, the one or more sinks in communication with the plumbing system.

In other embodiments, the mobile salon vehicle includes a heating, ventilation, and air conditioning (HVAC) unit, powered by the generator, and operable to provide conditioned air within the interior space of the vehicle. An entry doorway for accessing the interior space of the mobile salon may also be provided. The mobile salon vehicle may also include one or more windows disposed in a sidewall of the mobile salon vehicle.

In other aspects of the invention, a method of providing spa services is disclosed. The method includes providing a motor vehicle platform having an interior space configured to a salon interior. The interior space includes a plurality of salon chairs mounted therein, each of the plurality of salon chairs having an integrated massaging foot tub, a plumbing system in communication with a water tank, a water heater providing a source of hot water for each massaging foot tub, and a generator providing a source of electrical power to the plurality of salon chairs. One or more clients are received via a doorway defined in a sidewall of the motor vehicle platform. One or more spa services are provided to the one or more clients seated in one of the plurality of salon chairs.

The one or more spa services may include a hot water foot massage. The one or more spa services may also include a pedicure. Some embodiments of the method include locating the motor vehicle platform at a place proximal to the client.

These and other features, aspects and advantages of the present invention will become better understood with reference to the following drawings, description and claims.

### BRIEF DESCRIPTION OF THE DRAWINGS

FIG. 1 is a partial side sectional view illustrating an interior of the mobile spa vehicle;

FIG. 2 is a second partial sectional view illustrating an interior of the mobile spa vehicle;

FIG. 3 is a front perspective view of a spa chair;

FIG. 4 is a side perspective view of a spa chair;

FIG. 5 is a top plan view of a water pump;

FIG. 6 is a side elevation view of a water pump;

FIG. 7 is a front elevation view of a water heater;

FIG. 8 is a side elevation view of a water heater;

FIG. 9 is a front elevation view of a generator; and

FIG. 10 is a side elevation view of a generator.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention include a mobile spa vehicle that provides a plurality of full service salon chairs, including a massaging foot tub, a hot water source for the massaging foot tub and associated plumbing for servicing the salon chair and vehicle.

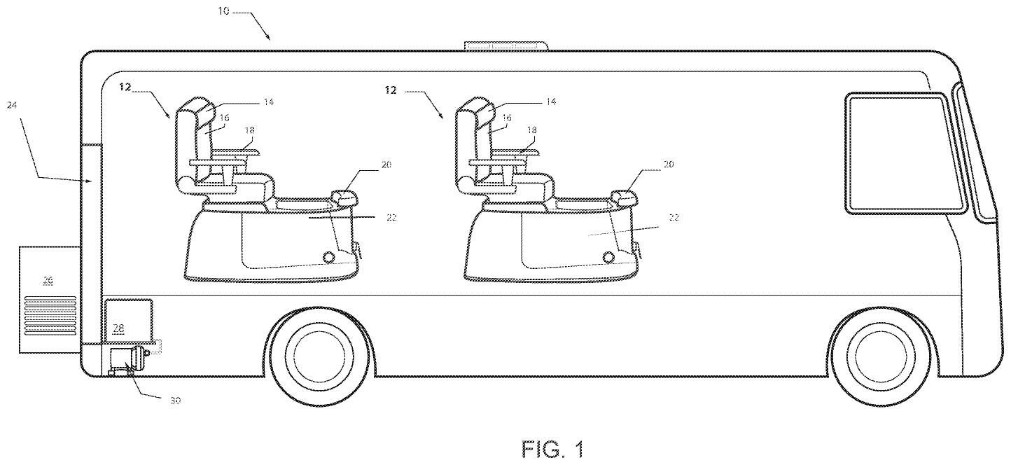

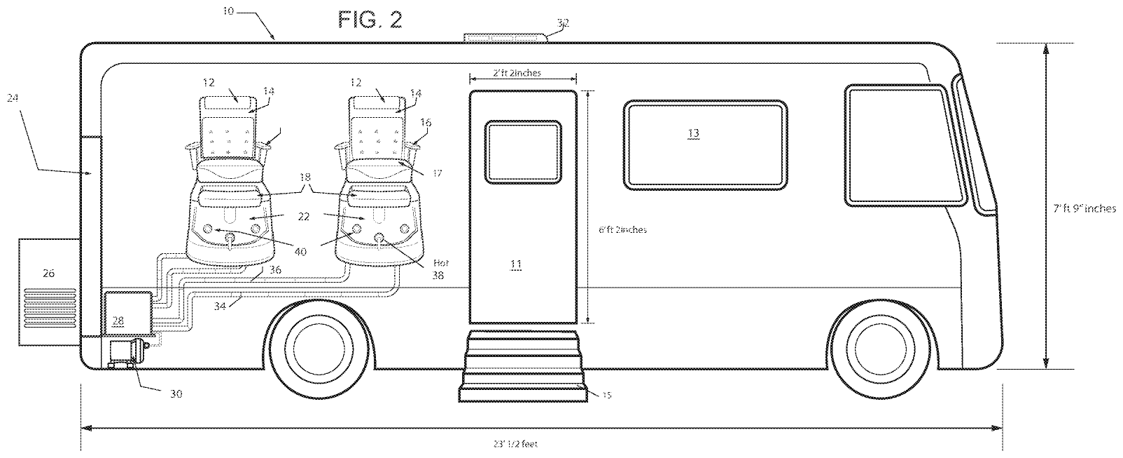

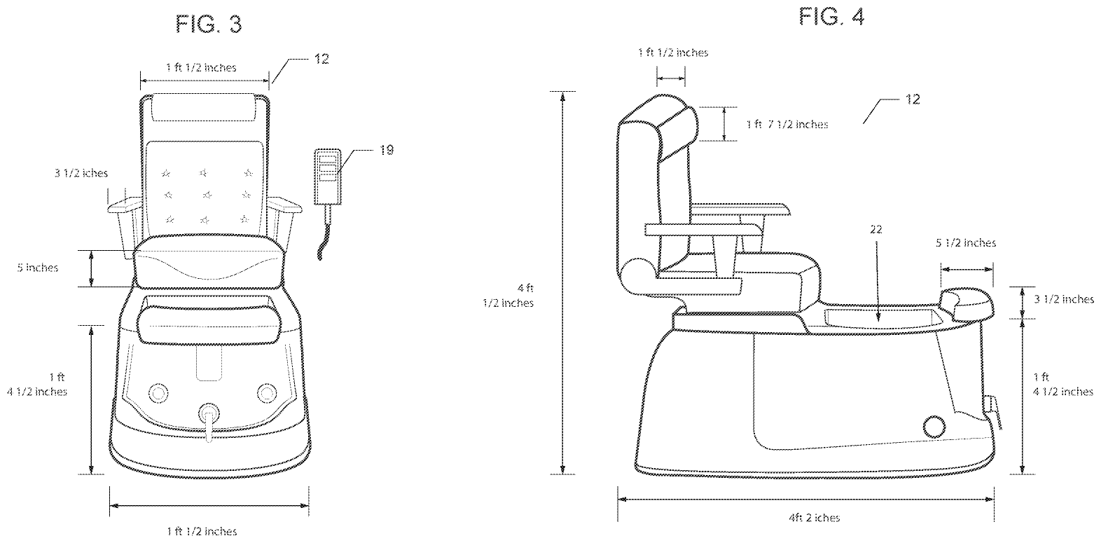

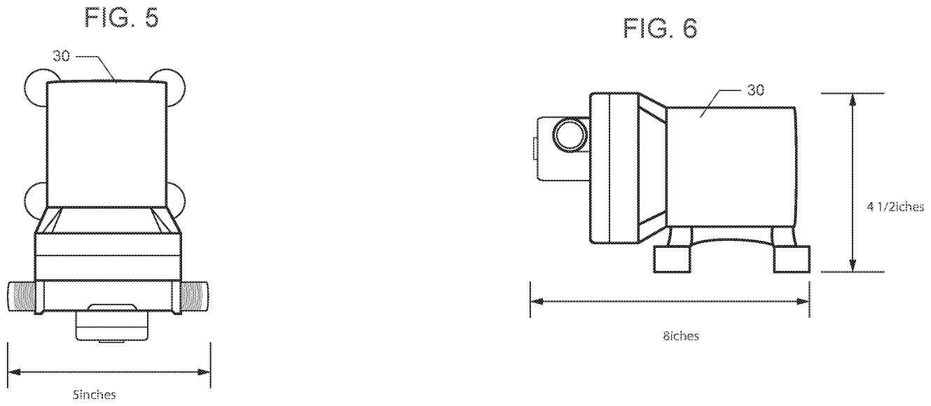

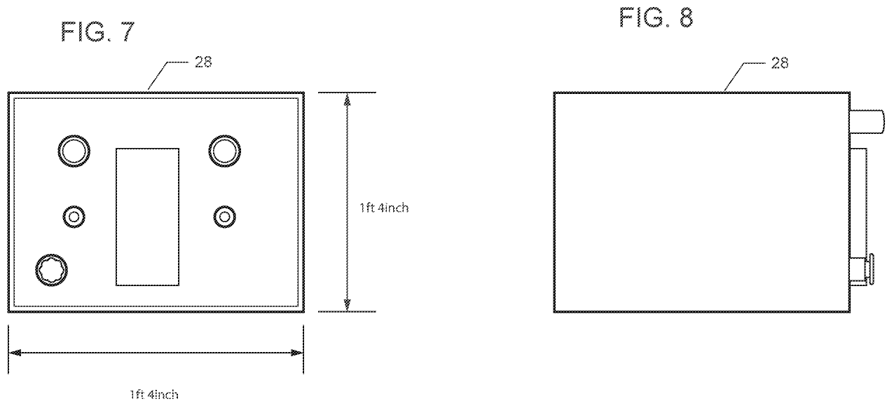

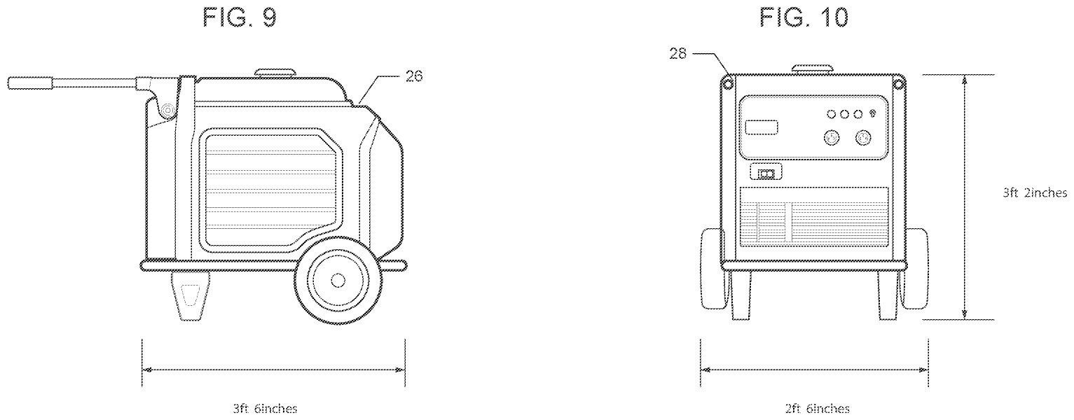

As seen in reference to the drawings of FIGS. 1-10, the mobile salon vehicle 10 includes a plurality of salon chairs 12 mounted in an interior space of the vehicle 10. The salon chairs may include a headrest, a backrest 16, an arm rest 18, a foot rest 20 and a massaging foot tub 22 in an integrated unit. Preferably, the salon chairs 12 may be reclined for the comfort of the clientele. The mobile salon vehicle 10 may be provided by any suitable vehicle, such as a recreational vehicle, a utility truck, or a trailer mounted platform. The vehicle 10 includes an entry doorway 11 and may include one or more windows 13. Steps 15 may also be provided to facilitate entry to the vehicle 10 via the doorway 11.

The vehicle 10 may include a water tank 24 containing a desired volume of water, for example 100 gallons, to supply the vehicle 10 for a predetermined duration or number of spa services provided by the operator of the vehicle. The vehicle 10 may also include a water heater 28 in fluid communication with the water tank 24 and the massaging foot tub 22. A water pump 30 is provided for communication of the water via a supply pipe, or conduit 34 and a drain pipe, or conduit 36. The water pump should be capable of delivering a 3 gallon per minute flow rate. The gray water may be collected in an on vehicle 10 containment reservoir or may be filtered and reprocessed for use in a sanitary condition.

The mobile salon vehicle 10 may also include a heating, ventilation, and air conditioning (HVAC) unit 32 which is provided to supply the interior space of the vehicle 10 with conditioned and filtered air for enjoyment by the patrons and salon care specialists within the vehicle 10. Power for the salon chair 12, water heater 28, water pump 30, and HVAC unit 32 is provided by a generator 26 via a power distribution panel and electrical conductors. The generator 26 may have a capacity of 7000 watts. The interior space may also include a plurality of outlets for powering one or more hand tools, such as pedicure nail drills, buffers, hair clippers, dryers, vacuum, and the like. The vehicle interior may also include one or more sinks, proximal to the chairs 12 for washing the client's hair as part of a hair style.

The reclining salon chair 12 with immovable tub 22 attached to the chair 12 is a comfortable place where the client sits to receive one or more spa treatments, such as a hot water foot massage. The salon chair may be controlled with a remote control 19. The vehicle 10 may be fitted with a plurality of compartments big enough to hold all devices, components and plumbing systems running unseen. Together they create one seamless process keeping client unaware of the system components working together in the mobile salon vehicle 10.

It should be understood, of course, that the foregoing relates to exemplary embodiments of the invention and that modifications may be made without departing from the spirit and scope of the invention as set forth in the following claims.

What is claimed is:

1. A mobile salon vehicle, comprising:
a motor vehicle platform having an interior space configurable to a salon interior;
a plurality of salon chairs mounted within the interior space, each of the plurality of salon chairs having an integrated massaging foot tub;
a plumbing system in communication with a water tank, providing a source of water to the massaging foot tub; and
a generator providing a source of electrical power to the plurality of salon chairs.

2. The mobile salon vehicle of claim 1, further comprising:
a water heater configured to provide a source of hot water to at least each of the plurality of salon chairs.

3. The mobile salon vehicle of claim 2, further comprising:
a water pump for communicating the source of water through the plumbing system.

4. The mobile salon vehicle of claim 3, further comprising:
one or more sinks positioned proximal to the plurality of salon chairs, the one or more sinks in communication with the plumbing system.

5. The mobile salon vehicle of claim 4, further comprising:
a heating, ventilation, and air conditioning (HVAC) unit, powered by the generator, operable to provide conditioned air within the interior space of the vehicle.

6. The mobile salon vehicle of claim 5, further comprising:
an entry doorway for accessing the interior space of the mobile salon.

7. The mobile salon vehicle of claim 6, further comprising:
one or more windows disposed in a sidewall of the mobile salon vehicle.

8. A method of providing spa services, comprising:
providing a motor vehicle platform having an interior space configured to a salon interior, the interior space including a plurality of salon chairs mounted therein, each of the plurality of salon chairs having an integrated massaging foot tub, a plumbing system in communication with a water tank and a water heater providing a source of hot water for the massaging foot tub, a generator providing a source of electrical power to the plurality of salon chairs;
receiving one or more clients via a doorway defined in a sidewall of the motor vehicle platform; and
and providing one or more spa services to the one or more clients seated in one of the plurality of salon chairs.

9. The method of claim 8, wherein the one or more spa services includes:
a hot water foot massage.

10. The method of claim 9, wherein the one or more spa services includes:
a pedicure.

11. The method of claim 10, further comprising:
locating the motor vehicle platform at a place proximal to the client.
